(19) United States
(12) Patent Application Publication
(10) Pub. No.: US 2010/0272127 A1
(43) Pub. Date: Oct. 28, 2010

(54) LASER APPARATUS WITH FEEDBACK FOR DISPERSIVE OUTPUT TO A PIN-HOLE ELEMENT

(76) Inventors: Tony Lam, Artesia, CA (US); ChenChun Wu, Salt Lake City, UT (US)

Correspondence Address: STETINA BRUNDA GARRED & BRUCKER, 75 ENTERPRISE, SUITE 250, ALISO VIEJO, CA, 92656, US

(21) Appl. No.: 12/428,902

(22) Filed: Apr. 23, 2009

(51) Int. Cl. H01S 3/30; H01S 3/13

(52) U.S. Cl. 372/5; 372/29.011

(57) ABSTRACT

There is provided a laser apparatus that includes a laser emitter configured to emit a laser emitter output beam. The apparatus includes a transmissive grating positioned with the laser emitter output beam incident upon the grating. The grating transmits a first order output beam. The apparatus includes a feedback element positioned with the first order emitted beam incident upon the feedback element. The feedback element returns a feedback element return beam incident upon the grating. The feedback element transmits a feedback element output beam at a feedback element output beam width. The laser apparatus includes a pin-hole element with a pin-hole positioned with the feedback element output beam incident upon the pin-hole. The feedback element output beam width is not greater than the pin-hole width. The pin-hole element transmits a pin-hole output beam at a pin-hole element output beam width less than the feedback element output beam width.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Traditionally, there are two basic methods of laser frequency stabilization in external-cavity lasers: Littrow and Littman configurations. A Littrow configuration facilitates a relatively simple operation and maximized laser output, but the resultant laser linewidth is relatively broad. A Littman configuration, a more complicated system, allows for a relatively narrower linewidth, but has less laser output. Both configurations utilize a zero order output from a grating. As a result both configurations tend to include strong ASEs (amplified spontaneous emission) that usually interfere with recording measurements.

In view of the foregoing, there is a need in the art for an improved laser device in comparison to the prior art.

### BRIEF SUMMARY

There is provided a laser apparatus. The laser apparatus includes a laser emitter configured to emit a laser emitter output beam. The laser apparatus further includes a transmissive grating positioned with the laser emitter output beam incident upon the grating. The grating is configured to transmit a first order output beam in response to the laser emitter output beam. The laser apparatus further includes a feedback element positioned with the first order output beam incident upon the feedback element. The feedback element is configured to return a feedback element return beam incident upon the grating. The feedback element is further configured to transmit a feedback element output beam at a feedback element output beam width. The laser apparatus further includes a pin-hole element including a pin-hole positioned with the feedback element output beam incident upon the pin-hole. The feedback element output beam width is not greater than a pin-hole width of the pin-hole. The pin-hole element is configured to transmit a pin-hole output beam at a pin-hole element output beam width less than the feedback element output beam width.

The grating and the feedback element is used to provide dispersive optical feedback to laser emitter. It is contemplated that an aperture of the laser emitter itself may be used as a bandwidth-limiting slit to accept only a slight portion of feedback light (as self-seeding feedback) and thus emits a relatively narrow linewidth. The pin-hole element has an effect of being a spatial filter and may greatly reduce ASE (depending upon an aperture size of the laser emitter). It is contemplated that the system may result in a relatively improved laser output (>50%), low ASE, narrow linewidth (double pass), and stable center wavelength in comparison to prior art designs. Further, it is contemplated that there are many potential applications for this invention, such as Raman spectroscopy, precision measurements, and remote sensing (but not limited to these applications).

According to various embodiments, the laser emitter output beam may have a wavelength of between 0.2 to 1.1 microns. In an embodiment, an energy of the first order output beam is at least 80% of an energy of the laser emitter output beam. The grating may have a thickness of between 5 to 50 microns. An angle of incidence of the laser emitter output beam upon the grating may be between 10 and 80 degrees. In an embodiment the angle of incidence of the laser emitter output beam upon the grating is about 45 degrees. The angle of emission of the first order output beam from the grating is between 10 and 80 degrees. In an embodiment, the angle of emission of the first order output beam from the grating is about 45 degrees. An energy of the pin-hole element output beam may be at least 80% of an energy of the feedback element output beam. The feedback element may be a partially reflective mirror.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts a symbolic view of the laser apparatus of an embodiment of the present invention.

### DETAILED DESCRIPTION

The detailed description set forth below in connection with the appended drawings is intended as a description of the presently preferred embodiment of the invention, and is not intended to represent the only form in which the present invention may be constructed or utilized. Reference throughout the detailed description to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this detailed description are not necessarily all referring to the same embodiment. The following description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments. In the following description, numerous specific details are shown to provide a thorough understanding of embodiments of the invention. One skilled in the relevant art will recognize, however, that the invention may be practiced without one or more of the specific details, or with other methods, components, materials, etc. In other instances, well-known structures, materials, or operations are not shown or described to avoid obscuring aspects of the invention. It is further understood that the use of relational terms such as first and second, and the like are used solely to distinguish one from another entity without necessarily requiring or implying any actual such relationship or order between such entities.

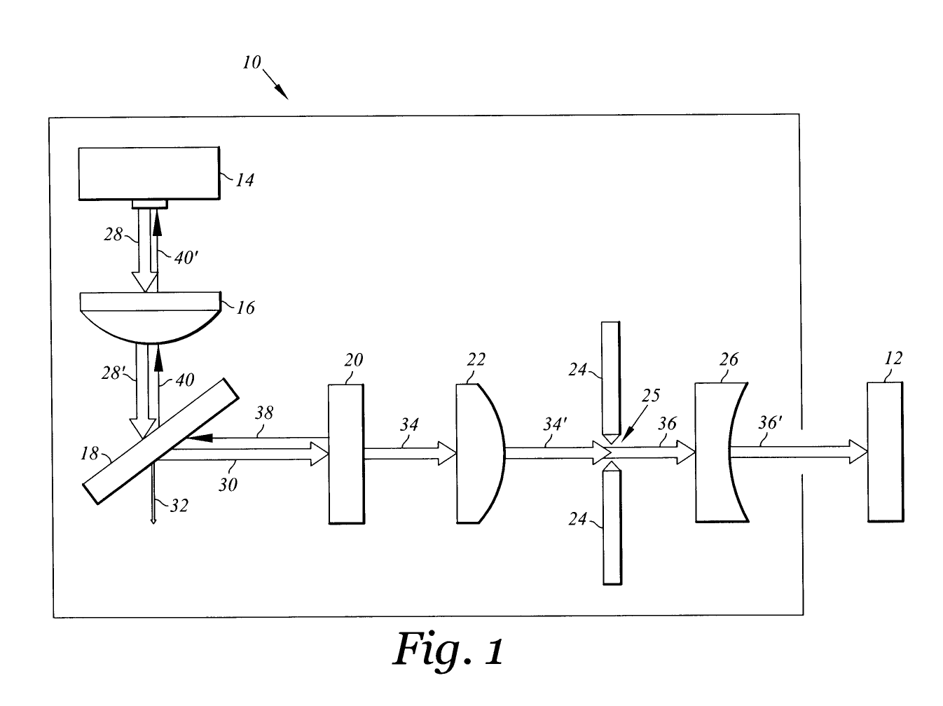

Referring now to FIG. 1, according to an aspect of the invention, there is depicted a symbolic view of a laser apparatus 10 for use with a sample 12. In this embodiment, the major components of the laser apparatus 10 are provided that include a laser emitter 14, a collimating lens 16, a transmissive grating 18, a feedback element 20, a focusing lens 22, a pinhole element 24, and a beam shaping lens 26.

According to an aspect of the invention, there is provided the laser apparatus 10. The laser apparatus 10 includes the laser emitter 14 configured to emit a laser emitter output beam 28. The laser apparatus 10 further includes the transmissive grating 18 positioned with the laser emitter output beam 28 incident upon the grating 18. The grating 18 is configured to transmit a first order output beam 30 in response to the laser emitter output beam 28. The laser apparatus 10 further includes the feedback element 20 positioned with the first order output beam 30 incident upon the feedback element 20. The feedback element 20 is configured to return a feedback element return beam 38 incident upon the grating 18. The feedback element 20 is further configured to transmit a feedback element output beam 34 at a feedback element output beam width. The laser apparatus 10 further includes the pin-hole element 24 including a pin-hole 25 positioned with the feedback element output beam 34 incident upon the pin-hole 25. The feedback element output beam width is not greater than a pin-hole width of the pin-hole 25. The pin-hole element 24 is configured to transmit a pin-hole output beam 36 at a pin-hole element output beam width less than the feedback element output beam width.

In further detail, the laser emitter 14 is configured to emit a laser emitter output beam 28. Depending upon the particular application of the overall laser apparatus 10, the laser emitter output beam may have a variety of wavelengths. For example, wavelength may range between 0.2 to 1.1 microns in certain applications. In the embodiment illustrated, the laser emitter output beam 28 is initially incident upon the collimating lens 16. The collimating lens 16 emits a laser emitter output beam 28′ that actually impinges upon the grating 18. An angle of incidence of the laser emitter output beam 28 upon the grating 18 may be between 10 and 80 degrees. In an embodiment illustrated, the angle of incidence of the laser emitter output beam 28 (and in particular 28′) upon the grating 18 is about 45 degrees.

The output of the grating 18 is dispersive in nature (with different wavelengths being directed at different directions). The grating 18 emits the first order output beam 30 and a zero order output beam 32 at different directions. The grating 18 may be configured to resulting in an energy of the first order output beam 30 being at least 80% of an energy of the laser emitter output beam 28. In this regard, the grating 18 is particularly configured to have a significantly low energy of the zero order output beam 32. The grating 18 may have a thickness of between 5 to 50 microns. The angle of emission of the first order output beam 30 from the grating 18 may be between 10 and 80 degrees. In the embodiment illustrated, the angle of emission of the first order output beam 30 from the grating is about 45 degrees. It is contemplated that the grating 18 is constructed in accordance with any of those methods that are well known to one of ordinary skill in the art. For example the grating 18 may be fabricated as a holographic type of grating with the use of a photosensitive emulsion and two laser beams may be used to create the grating pattern. The grating 18 may be characterized by a groove density that is a significant factor in the angle of emission.

In this embodiment, the first order output beam 30 impinges upon the feedback element 20. The feedback element 20 is configured to return a feedback element return beam 38 incident upon the grating 18 and to transmit a feedback element output beam 34. The feedback element 20 may take the form of any of those devices that are well known to one of ordinary skill in the art. For example, the feedback element 20 may be a partially reflective mirror. The feedback element return beam 38 is emitted back to the grating 18. In response the grating 18 emits a grating return beam 40. In this embodiment, the grating return beam 40 is projected through the collimating lens 16. In turn, the collimating lens 16 emits a grating return beam 40′ to the laser emitter 14. The grating return beam 40 (and directly in this embodiment, the grating return beam 40′) is used by the laser emitter 14 to stabilize or otherwise lock the laser with respect to the frequency output of the laser emitter output beam 28. As such, the grating 18 and the feedback element 20 are used to provide dispersive optical feedback to laser emitter 14. It is contemplated that an aperture of the laser emitter 14 itself may be used as a bandwidth-limiting slit to accept only a slight portion of feedback light (as self-seeding feedback) and thus emits a relatively narrow linewidth.

The feedback element 20 emits the feedback element output beam 34. In this embodiment the feedback element output beam 34 impinges upon a focusing lens 22. The focusing lens 22 emits a feedback element output beam 34′ that is focused at the pin hole 25 of the pin-hole element 24.

The pin-hole element 24 emits the pin-hole element output beam 36. In this embodiment, the pin-hole element output beam 36 impinges upon the beam-shaping lens 26. In turn, the beam-shaping lens 26 emits a pin-hole element output beam 36′ upon the sample 12. An energy of the pin-hole element output beam 36 may be at least 80% of an energy of the feedback element output beam 34. The pin-hole element output beam width may be less than the feedback element output beam width. The pin-hole element 24 has an effect of being a spatial filter and may greatly reduce ASE (depending upon an aperture size of the laser emitter 14). By using the focusing lens 22 and a pin-hole element 24, unwanted ASE is thus blocked out. As a result the pin-hole element output beam 36 exhibits a relatively a good beam quality and very low ASE. In this regard, the pin-hole element 24 acts as a band pass filter that lets only a narrow/small portion of the laser frequencies pass while removing unwated ASE (noise) form the laser emitter 14.

It is contemplated that the various individual components, namely, the laser emitter 14, the collimating lens 16, the grating 18, the feedback element 20, the focusing lens 22, the pinhole element 24, and the beam shaping lens 26, may each be constructed in accordance with any of those methods that are well known to one of ordinary skill in the art.

It is contemplated that the system may result in a relatively improved laser output (>50%), low ASE, narrow linewidth (double pass), and stable center wavelength in comparison to prior art designs. Further, it is contemplated that there are many potential applications for this invention, such as Raman spectroscopy, precision measurements, and remote sensing (but not limited to these applications).

What is claimed is:

1. A laser apparatus comprising:
a laser emitter configured to emit a laser emitter output beam;
a transmissive grating positioned with the laser emitter output beam incident upon the grating, the grating configured to transmit a first order output beam in response to the laser emitter output beam;
a feedback element positioned with the first order output beam incident upon the feedback element, the feedback element configured to return a feedback element return beam incident upon the grating, the feedback element further configured to transmit a feedback element output beam at a feedback element output beam width; and
a pin-hole element including a pin-hole positioned with the feedback element output beam incident upon the pin-hole, the feedback element output beam width not being greater than a pin-hole width of the pin-hole, the pin-hole element being configured to transmit a pin-hole output beam at a pin-hole element output beam width less than the feedback element output beam width.

2. The laser apparatus of claim 1 wherein the laser emitter output beam has a wavelength of between 0.2 to 1.1 microns.

3. The laser apparatus of claim 1 wherein an energy of the first order output beam is at least 80% of an energy of the laser emitter output beam.

4. The laser apparatus of claim 1 wherein the grating has a thickness of between 5 to 50 microns.

5. The laser apparatus of claim 1 wherein an angle of incidence of the laser emitter output beam upon the grating is between 10 and 80 degrees.

6. The laser apparatus of claim 1 wherein an angle of incidence of the laser emitter output beam upon the grating is about 45 degrees.

7. The laser apparatus of claim 1 wherein an angle of emission of the first order output beam from the grating is between 10 and 80 degrees.

8. The laser apparatus of claim 1 wherein an angle of emission of the first order output beam from the grating is about 45 degrees.

9. The laser apparatus of claim 1 wherein an energy of the pin-hole element output beam is at least 80% of an energy of the feedback element output beam

10. The laser apparatus of claim 1 wherein the feedback element is a partially reflective mirror.
